(19) United States
(12) Patent Application Publication
(10) Pub. No.: US 2009/0320598 A1
(43) Pub. Date: Dec. 31, 2009

(54) METHOD FOR TESTING THE MICROSTRUCTURE OF A WELDED JOINT

(76) Inventors: Korbinian Puchner, Wessling (DE); Michael Siegel, Wesel (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/310,145

(22) PCT Filed: Aug. 2, 2007
(86) PCT No.: PCT/EP2007/058003

§ 371 Date: Feb. 12, 2009

(30) Foreign Application Priority Data
Aug. 16, 2006 (EP) 06017048.7

(51) Int. Cl. G01N 29/04

(52) U.S. Cl. 73/588

(57) ABSTRACT

A method for testing the microstructure of a welded joint for interior damage due to material creepage, with the following steps is disclosed: creating at least one ultrasonic surface wave by a first test head, receiving of the ultrasonic surface wave by a second test head, determining the acoustic properties within the structural conditions on the basis of the relation between a created and received ultrasonic surface wave, and determining the degree of damage of the interior structural conditions on the basis of the acoustic properties ascertained.

### CROSS REFERENCE TO RELATED APPLICATIONS

This application is the US National Stage of International Application No. PCT/EP2007/058003 filed Aug. 2, 2007 and claims the benefit thereof. The International Application claims the benefits of European application No. 06017048.7 EP filed Aug. 16, 2006, both of the applications are incorporated by reference herein in their entirety.

### FIELD OF INVENTION

The invention relates to a method for testing the microstructure of a welded joint for internal damage, or damage extending from the outer surface of a component into more deeply lying cross sections, for example due to material creep.

### BACKGROUND OF INVENTION

Particularly in power engineering, very stringent requirements in respect of the quality of the microstructure are demanded of welded joints, for example on turbine components such as fresh steam pipes from a boiler to the turbine per se or pipes inside the turbine. These welded joints are furthermore subject to very heavy loads. In contrast to systems stressed only in the yield point range or elevated-temperature yield point range, components which operate at very high temperatures have a limited lifetime due to material creep. In order to ensure the safety and availability of such components which are subject to material creep, reliable tests need to be carried out in particular on the associated welded joints. This applies in particular for the fresh steam pipes operated in the endurance range.

### SUMMARY OF INVENTION

In order to test such welded joints, only conventional structural replica techniques (metallographic examinations) on the direct component surface are known to date. Owing to the high outlay for such tests, only limited and predefined regions can be examined. Other regions, however, remain untested. Furthermore, this labor- and time-intensive testing technique requires very well-trained and experienced personnel. Lastly, the results must also be assessed subjectively by the testing personnel, which may result in widely varying evaluations.

It is an object of the present invention to provide a method for testing the microstructure of a welded joint, with which the aforementioned disadvantages can at least be reduced. The method should in particular be less labor- and time-intensive, and therefore more economical and more reliable overall.

The object is achieved by a method according to the independent claim. Advantageous refinements of the invention are described in the dependent claims.

According to the invention, a method having the following steps is used to test the microstructure of a welded joint for internal damage: generating at least one ultrasound surface wave by means of a first test head, receiving the at least one ultrasound surface wave by means of a second test head, determining the acoustic properties, particularly the velocity of sound, in the microstructure of the welded joint on the basis of the relationship between the generated and received ultrasound surface waves, determining the degree of damage of the internal microstructure of the welded joint on the basis of the acoustic properties which are found.

In other words, test heads which allow highly accurate measurement of the acoustic properties, particularly the velocity of sound of ultrasound waves, are used to test the microstructure of a welded joint. The ultrasound waves are emitted from the surface into the depth of the welded joint, and they propagate in particular as ultrasound waves of differing penetration depth inside the microstructure (Rayleigh surface wave). The acoustic properties are not measured with sound pulses, as is conventional, but instead with the aid of a continuous surface wave. With this method, damage of the welded joint can already be identified very economically at the early stage, particularly on endurance-damaged power plant components. The method furthermore advantageously comprises the steps: determining the phase shift between the at least one transmitted ultrasound surface wave and the at least one received ultrasound surface wave and determining the acoustic properties, particularly the velocity of sound, in the microstructure on the basis of the phase shift which is found. In order to determine the phase shift between the at least one transmitted ultrasound surface wave and the at least one received ultrasound surface wave, wideband piezoelectric test heads are preferably used with a corresponding forward wedge, which are fed with a sinusoidal voltage signal from a function generator. The transmission signal and a preamplified reception signal are delivered simultaneously to separate channels of an oscilloscope, so that the phase shift between the two signals can be determined.

In order to determine the phase shift between the at least one transmitted ultrasound surface wave and the at least one received ultrasound surface wave, the two test heads are furthermore preferably moved relative to one another. This movement of the test heads may be carried out by means of mechanized manipulators, which comprise in particular a highly precise displacement measurement system. In this way, exactly reproducible displacement of the two test heads is possible without play. When the receiving test head is displaced relative to the transmitting test head, the phase shift of the aforementioned oscillations of the transmitter and receiver signals relative to one another changes. The phase relation may be found not only by displacing the test heads but also electronically, in particular by using a radiofrequency comparator circuit. This obviates any manipulation of the test heads, and the displacement measurement system can also be omitted. A change in the phase shift by a complete phase cycle of 2π corresponds to a traveling displacement of exactly one wavelength.

Particularly preferably, in the method the test heads are moved relative to one another over a distance equal to the length of several wavelengths and the wavelength of the ultrasound surface wave in the microstructure is calculated as an average therefrom. By averaging the wavelength over the traveling displacement of the test heads, it is possible to achieve very high measurement accuracy.

For the accurate determination of internal damage to the microstructure of a welded joint by means of the method, the following steps are furthermore provided: varying the frequency of the at least one transmitted ultrasound surface wave and determining the acoustic properties in the microstructure on the basis of the gradient of the corresponding variation in the wavelength of the at least one received ultrasound surface wave. Using the velocity profile thus found for ultrasound waves inside the microstructure, the required information about damage to the welded joint can be obtained over the associated material cross section. As already mentioned, on the one hand the absolute value of the velocity of sound and on the other hand the gradient of the velocity profile may be used as evaluation criteria for this. Relative measurements may also be carried out. In this case, the change in the phase relation with a constant test frequency is evaluated over the weld seam cross section. In addition, comparative measurements may be carried out on less stressed positions of the same component.

In the method, two test heads acting as receivers are furthermore preferably set to phase coincidence of the ultrasound surface waves received by them in order to determine the phase shift. The measurement quality can be increased further in this way since, with such a head-to-head arrangement, the metrologically relevant test head spacing could be modified by a wave exit point from the forward wedge of the test head that varies with the measurement frequency. This is overcome by comparable conditions for the signal reception with two test heads, acting as receivers, with an identical orientation.

In order to allow layer by layer scanning of the welded joint to be tested, it is advantageous to generate and receive successive ultrasound surface waves which have different wavelengths, and in this way to generate layer by layer testing of the welded joint from the surface into its depth.

Lastly, in the method it is also advantageous to carry out coarse-grid scanning of the welded joint initially, particularly in its transverse direction, and subsequently to carry out refined scanning of internal damage found in the microstructure. The refined scanning is in particular preferably carried out in the longitudinal direction of the welded joint in question.

### BRIEF DESCRIPTION OF THE DRAWINGS

Exemplary embodiments of the method according to the invention for testing the microstructure of a welded joint for internal damage will be explained in more detail below with the aid of the appended schematic drawings, in which:

FIG. 1 shows a cross section of a component tested by the method,

FIG. 2 shows the profile of measurement curves on a damaged component tested and an undamaged component tested,

FIG. 3 shows further profiles of measurement curves on such components,

FIG. 4 shows a perspective view of a component tested in so-called coarse scanning,

FIG. 5 shows a perspective view of a component tested in so-called fine scanning,

FIG. 6 shows a perspective view of a component tested with the position of measurement tracks being indicated,

FIG. 7 shows a first exemplary embodiment of a measurement setup for the method,

FIG. 8 shows a second exemplary embodiment of a measurement setup for the method,

FIG. 9 shows a third exemplary embodiment of a measurement setup for the method and

FIG. 10 shows a schematic representation of the evolution of the measurement parameters found over the exposure time of a component stressed at high temperature.

### DETAILED DESCRIPTION OF INVENTION

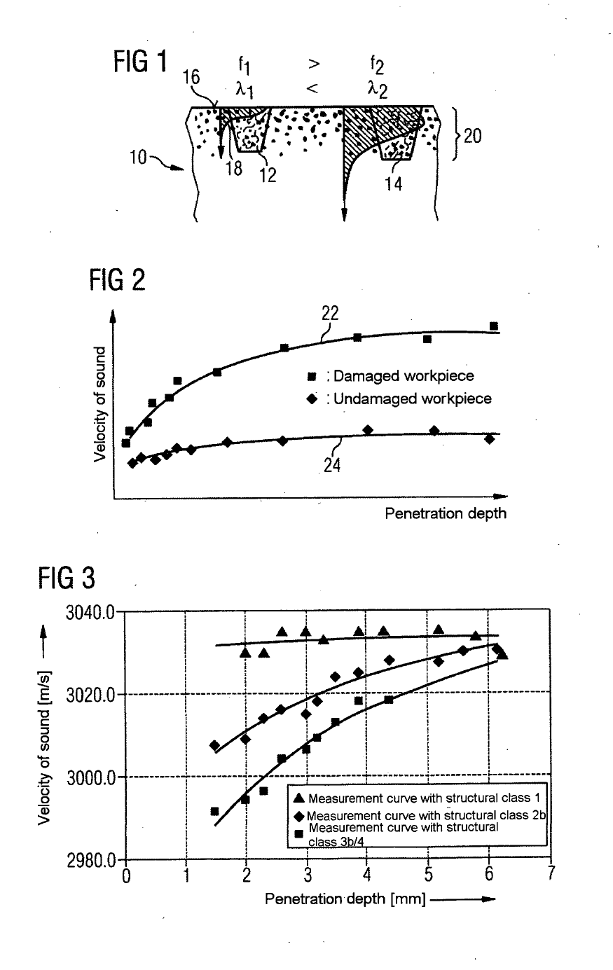

FIG. 1 illustrates a cross section of a component 10, on which there is a first weld seam 12 and a second weld seam 14. These two weld seams 12 and 14 are examined with a method for testing the microstructure for internal damage, in particular for endurance damage, for example due to material creep. An ultrasound surface wave is generated on a surface 16 of the component 10 in a test head (not represented in FIG. 1) and is received or picked up by means of a second test head (likewise not represented in FIG. 1). From a comparison of the received ultrasound surface wave with the transmitted ultrasound surface wave and a velocity of sound, calculated therefrom, in the microstructure of the component 10, the degree of damage to the microstructure can be determined as explained in more detail below. The method allows depth-dependent testing of endurance-stressed or endurance-damaged welded joints. This testing is possible even on an inhomogeneous microstructure, which is generally encountered in welded joints, with large local and depth-dependent differences in the material properties.

The method furthermore ensures that the result is based purely on physical quantities and is obtained objectively.

Besides recording the absolute value of the velocity of sound in the microstructure of the component 10, the penetration depth of the transmitted ultrasound surface waves may also be modified by varying their frequency. With these so-called Rayleigh waves, it is possible to compile a depth profile of the velocity of sound in the microstructure of the component 10. By controlled integral recording of the acoustic properties at different penetration depths, the ultrasound surface waves can thereby be used to compile a sound velocity profile whose shape is sensitively influenced by any progress of damage on the component 10. This represents a considerable detection advantage, particularly for the assessment of endurance damage.

FIG. 1 illustrates that, assuming a maximal pore concentration at the surface 16, a low penetration depth ultrasound surface wave 18 initially penetrates only through a region 20 of the most strongly damaged microstructure. Assuming a constant decrease in the damage with the depth of the component 10, the less damaged material fraction recorded integrally by the ultrasound surface wave 18 increases proportionally with an increasing penetration depth (see FIG. 1).

A sound velocity minimum is therefore measured as the position of greatest damage on the surface 16, while an increase in the velocity of sound is to be observed owing to the pore concentration decreasing with an increasing penetration depth. For this, FIG. 1 illustrates a variation in a frequency f of from f₁ to f₂, which lies in a range of from 400 kHz to 3 MHz. Correspondingly, the wavelength λ of the associated ultrasound surface wave changes from a value λ₁ to a value λ₂ with penetration depths of about 1 mm to about 8 mm.

FIG. 2 illustrates that creep damage near the surface consequently leads to a velocity of sound differing significantly between the surface 16 and a more deeply lying region of the component 10 (see measurement curve 22), while a virtually constant depth profile is to be observed in damage-free or undamaged material (see measurement curve 24). From the curvature ratio of the measurement curves 22 and 24 or their curve gradient, it is therefore possible to deduce the progress of damage in relation to the surface 16 as a reference region.

A plurality of frequencies are selected, so as to obtain a number of layers or sampling points which describe the profile of the velocity of sound in relation to the distance from the surface 16. Frequencies of between about 400 kHz and about 3 MHz are selected, as mentioned, which gives a penetration depth of up to 8 mm for the materials conventionally to be examined. The measurement depth with the method of this type is therefore considerable.

In order to carry out a comparative evaluation of the profiles of the measurement data, or the measurement curves 22 and 24 illustrated in FIG. 2, their profile is described mathematically. FIG. 3 represents an exemplary comparison of various real measurement data. The depth profiles of the sound velocities in respect of the parameters absolute value of the velocity of sound, depth profile of the velocity of sound and measurement range (minimum/maximum penetration depth) sometimes vary significantly.

In order to allow in particular computer-assisted assessment of the measurement data, it is therefore desirable to have a mathematical description of the data but without suppressing important information from their profile. Comprehensive regression analysis of a multiplicity of measurement data has revealed that the depth profile of the measurement data can be described by a logarithmic regression law of the form cᵢₙₜ=K*ln(t)+c₀. Here, t is the depth coordinate, cᵢₙₜ is an integral measurement value of the velocity of sound, c₀ is the value of the absolute velocity of sound at t=0 (surface 16) and K is a gradient coefficient or a gradient number.

The equation satisfies the requirements for a mathematical description model in a substantially optimal way. Two characteristic quantities are therefore sufficient in order to describe all the measurement curves, namely the specification of a surface sound velocity c₀ and a gradient coefficient K.

Besides finding the velocity of sound c₀ as a determining quantity for the absolute values of sound velocities inside the microstructure of the component 10, the integral velocity of sound at an arbitrary position inside the component may be calculated from the known curve profile. When applying this procedure to welded joints, or the weld seams 12 and 14 represented in FIG. 1, measured and calculated sound velocities in deeper microstructures can thus be compared with one another.

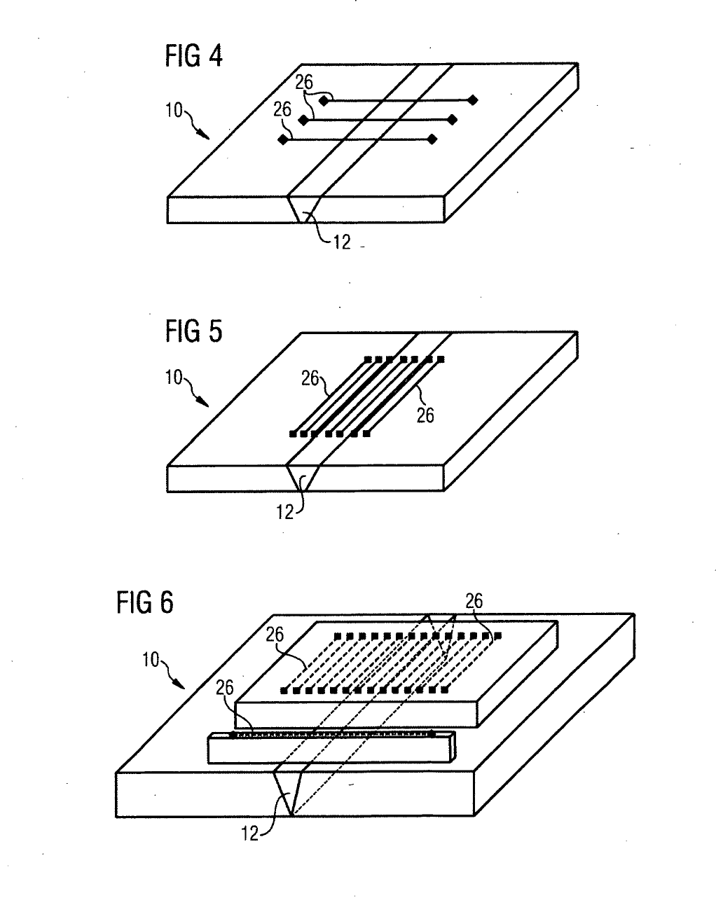

FIGS. 4 to 6 illustrate the spatial procedure in the method for testing the microstructure of a weld seam 12 on a component 10. So-called coarse scanning (FIG. 4) is initially carried out for an overview assessment, with individual measurement tracks 16 being directed transversely to the longitudinal extent of the weld seam 12.

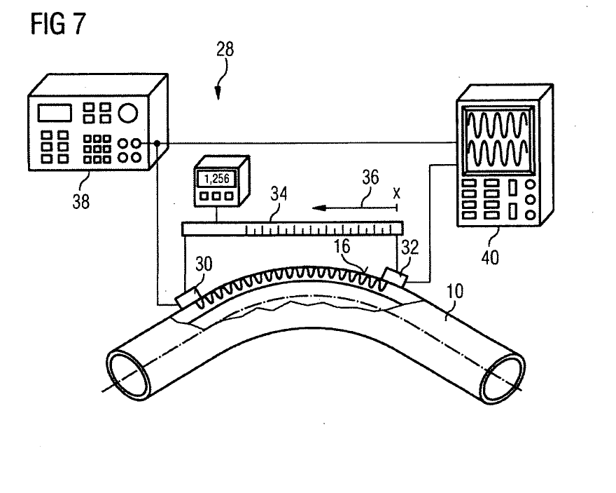

These measurement tracks 26 represent the path between two test heads (illustrated below in FIGS. 7 to 9), which are displaced individually or optionally together along these measurement tracks 26. By the coarse scanning illustrated in FIG. 4, defects are detected in the microstructure of the weld seam 12 and in the immediately surrounding component. In a second method step illustrated in FIG. 5, i.e. the so-called fine scanning, individual measurement tracks 26 are subsequently oriented parallel to the longitudinal extent of the weld seam 12. In this way, a detailed assessment of the material volume is carried out. Both a sound velocity profile and a gradient profile of measurement curves, such as are illustrated in FIGS. 2 and 3, are obtained from the individual measurements oriented in this way. Progressive damage to the weld seam 12 can be deduced from the variation in these measurement curves during the lifetime of the associated component.

FIG. 6 again illustrates that full characterization of a weld seam 12 in its spatial extent is possible, this spatial extent being given by the length of the measurement tracks 26, their number and the spacing of the individual measurements, as well as the penetration depth of the ultrasound surface waves.

FIG. 7 illustrates a first exemplary embodiment of a measurement setup 28 for carrying out the method. A first test head 30, acting as a transmitter for ultrasound surface waves, and a second test head 32, acting as a receiver of the ultrasound surface waves, are provided. The two test heads 30 and 32 are arranged on a manipulator 34, by means of which virtually play-free and exactly reproducible displacement of the two measurement heads 30 and 32 is ensured along a straight line on the component 10 to be tested. The relative traveling position of the two test heads 30 and 32 is recorded by means of a highly precise displacement measurement system 36.

The test head 30 acting as a transmitter, which is configured as a wideband piezoelectric test head with a corresponding forward wedge, is fed with a sinusoidal voltage signal from a function generator, while generating a continuous ultrasound surface wave. This ultrasound surface wave propagates on the surface 16 of the component 10 along an axis of the test head 30 and is picked up by the test head 32, which in the present case is arranged oppositely directed. The transmitter signal and the signal received by the test head 32, after it has been preamplified, are delivered simultaneously to separate channels of an oscilloscope 40 so that a phase shift between the two signals can be determined.

At the same time, the test head 32 acting as a receiver is displaced relative to the test head 30 acting as a transmitter so as to provide a phase shift of the transmitter oscillation relative to the receiver oscillation. A change in the phase shift by a complete phase cycle of 2π corresponds to a traveling displacement of exactly one wavelength.

Depending on the dimensions of the component 10 to be tested and the size of the test heads 30 and 32 being used, the displacement path during a measurement process is from about 50 mm to about 100 mm, the change in the phase shift being recorded as a function of the measurement length. Based on taking into account the number of phase shifts executed and the length of the measurement distance, the data found in this way make it possible to calculate an average wavelength of the ultrasound surface wave in the component 10. The velocity of sound c in the component 10 is then calculated with the aid of the wavelength λ and the frequency f, which is set by the frequency generator 38. By averaging the wavelength over the traveling displacement of the test heads 30 and 32, very high measurement accuracy can thereby be achieved.

With such a measurement method, as explained above, damage existing near the surface in the microstructure of a weld seam 12 or 14 on the component 10 leads to a depth-dependent gradient of the ascertained velocity of sound c, and conclusions about the degree of damage to the weld seam 12 or 14 can be obtained by evaluating the velocity profile over its cross section.

It is possible to detect defects within a short time by the coarse scanning explained above (FIG. 4), and conspicuous measurement points are subsequently subjected to detailed fine scanning (FIG. 5) in a refined test process (by using a plurality of measurement frequencies).

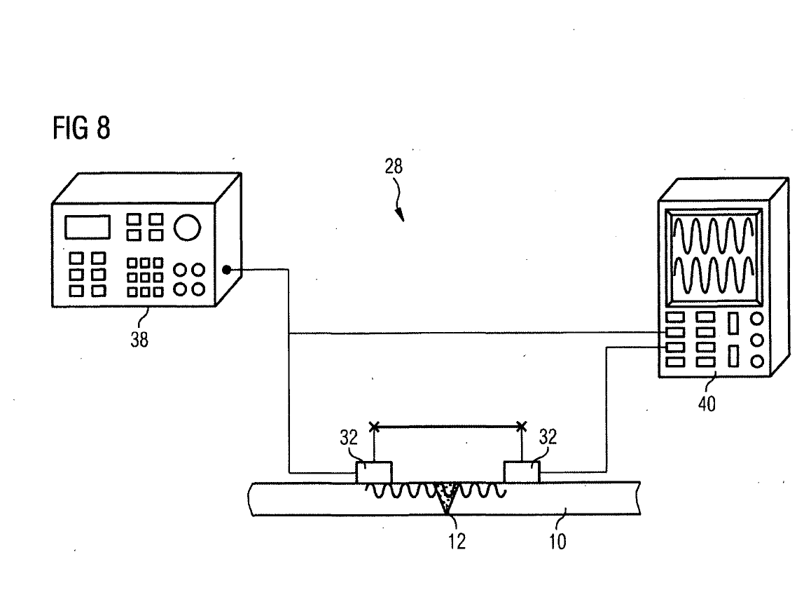

FIG. 8 illustrates an alternative embodiment of a measurement setup 28, in which two test heads 30 and 32 are respectively arranged in a fixed test head arrangement. These test heads 30 and 32 are again respectively connected to a function generator 38 and an oscilloscope 40. In contrast to the measurement setup 28 represented in FIG. 7, displacement of the test heads 30 and 32 by means of a manipulator is not provided in this case; instead, the test heads 30 and 32 are arranged stationary and the measurement frequency for them is modified as a variable quantity. This procedure obviates the costs for a manipulator and the displacement measurement system. Furthermore, the measurement can be carried out fully automatically.

The arrangement according to FIG. 8 may also be used to evaluate a change in the phase relation between the two signals relative to a reference quantity (for example basic material) with constant test head spacing. To this end, the rigid arrangement of the test heads 30 and 32 is moved over the weld seam and the local changes in the phase relation in response to material modifications are evaluated. This may be done electronically (comparator circuit). The frequency range and therefore the depth action of the method remain unaffected by this.

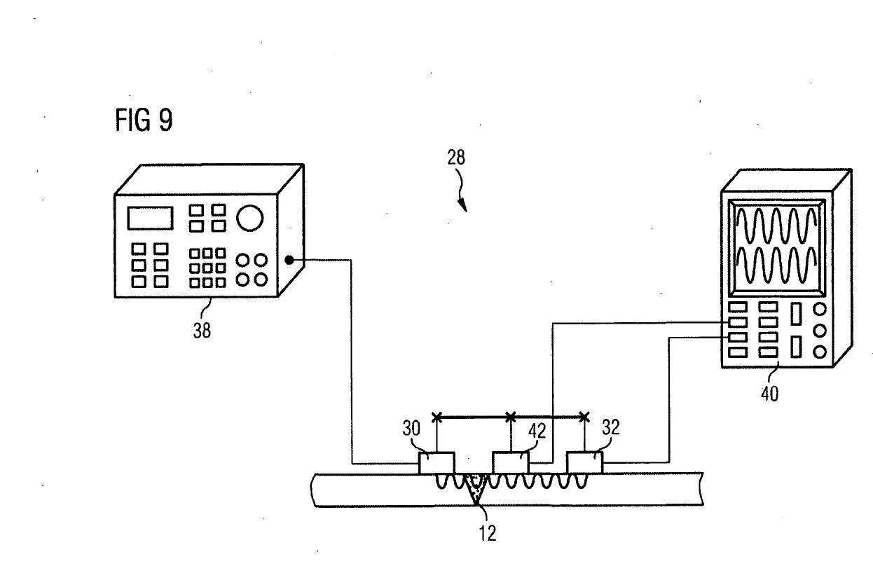

FIG. 9 illustrates an embodiment of a measurement setup 28 in which a total of three stationary test heads 30, 32 and 42 are provided, of which the test head 30 is connected to a function generator 38 and the test heads 32 and 42 are connected to an oscilloscope 40 while acting as receivers. The signals of the two test heads 32 and 42 acting as receivers are set to phase coincidence. The precision of the measurement can be increased further in this way since, with a head-to-head arrangement, the metrologically relevant test head spacing could be modified by an exit point from the forward wedge of the associated test head that varies with the measurement frequency, but this can be overcome by the comparable conditions provided here for the signal reception at the two test heads 32 and 42 acting as receivers, with an identical orientation.

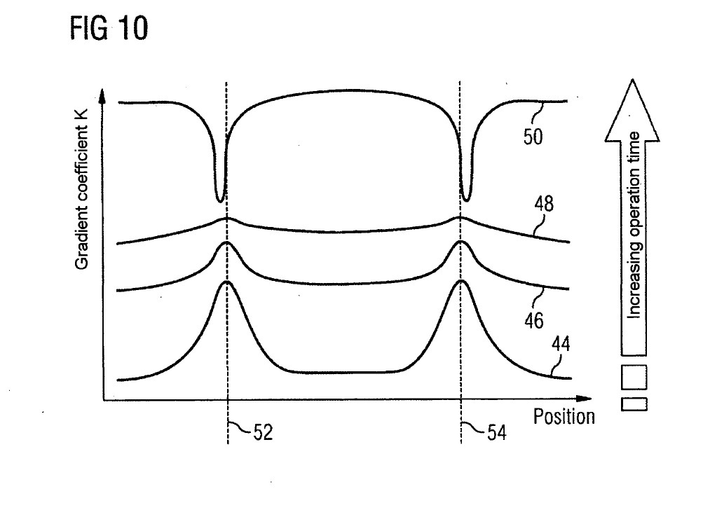

FIG. 10 illustrates an evaluation of profiles of the value of the velocity of sound over the cross section of one of the weld seams 12 and 14. FIG. 10 illustrates that the sound velocity profile makes it possible to describe the state of damage of the microstructure of a weld seam.

FIG. 10 shows in total four curves 44, 46, 48 and 50, each of which illustrates the profile of the gradient of the velocity of sound as a function of a position transverse to a longitudinal extent of a weld seam. The line 44 shows a weld seam in the new state, the line 46 shows an operationally stressed weld seam, the line 48 shows a weld seam further stressed by operation, and line 50 lastly shows a weld seam with a damaged microstructure.

The line 44 essentially has an M-shape, which extends with its two maxima respectively in the region of fusion lines 52 and 54. These fusion lines respectively form the boundary region between one side of the weld seam and the adjacent component.

Besides the sound velocity maxima in the vicinity of the fusion lines 52 and 54, a bulk sound velocity decrease takes place in the heat influx zones of the weld seam after a homogenization phase. A decreasing trend of the velocity of sound is furthermore to be observed both in the welding material of the weld seam and in the basic material of the associated component.

The essentially M-shaped line 44 of this type becomes increasingly flattened as the operating time of the associated component increases (see lines 46 and 48 in FIG. 10). In the damaged state of the weld seam, an essentially W-shaped line 50 is finally obtained, this change in the gradient coefficient K from an M-shape in the new state, through flattening in the operationally stressed state, to a W-shape in the damaged state clearly showing the qualitative evolution profile at the associated weld seam.

By means of an analysis of the specimen-specific profiles of the gradient coefficient K and a comparison of the depth profiles of the sound velocities c at the associated measurement points, precise assessment of weld seams is therefore possible.

The qualitatively similar profile of the gradient coefficient K and the velocity of sound c is purely coincidental. Specifically, the material modifications reflected in the two quantities K and c are based on different processes. While the velocity of sound c describes the structural state in respect of a lifetime curve, the gradient coefficient K gives information about the depth-dependent profile of the acoustic properties.

In the initial state of a weld seam, the microstructure has a very inhomogeneous distribution of different states particularly in the vicinity of the fusion lines (solidification structure).

This is expressed within the measurement curves or lines 44 to 50 by a more highly pronounced gradient coefficient K limited locally to these regions. When flattening in the profile of the gradient coefficient K over the weld seam cross section can be seen, long-term operational stress at a high temperature level is metrologically detected. This is because such stress leads, through so-called recovery annealing, to progressive reduction of these local inhomogeneities and therefore to smaller differences of the acoustic properties inside the weld seam. Such a development has been widely confirmed on endurance-stressed pipe bends, where it is manifested by an increase in the velocity of sound during this “homogenization phase” until a decrease in the absolute values of the velocity of sound c is finally to be observed when irreversible damage sets in.

On welded joints, endurance damage evidently leads to depth-independent damage of the regions at the fusion lines 52 and 54, which can be substantiated by the local reduction in the velocity of sound c over the entire penetration depth of the associated ultrasound surface wave. While this measurement effect extends over a larger material volume in the vicinity of the fusion lines 52 and 54 in the initial state, a displacement of the centroid of the damage in the direction of the thermal fusion lines 52 and 54 is also to be seen after endurance damage has set in. In particular, the material lattice or material structure inside the fusion lines 52 and 54 (fine-grain zone) therefore reacts particularly sensitively to any time-dependent material modification and thus represents the function of an early indicator. Comparing said parameters of the sound velocities and their magnitude, above all transversely over a weld seam, therefore represents a sensitive method for characterizing the state of weld seams even in the early damage stage.

1.-8. (canceled)

9. A method of testing microstructure of a welded joint for internal damage, for example due to material creep, comprising:
generating an ultrasound surface wave by a first test head;
receiving the ultrasound surface wave by a second test head;
displacing the first test head along a measurement track parallel to the longitudinal extent of the welded joint;
determining acoustic properties in the microstructure based upon the relationship between the generated and received ultrasound surface waves; and
determining a degree of damage of the microstructure based upon the acoustic properties.

10. A method of testing microstructure of a welded joint for internal damage, for example due to material creep, comprising:
generating an ultrasound surface wave by a first test head;
receiving the ultrasound surface wave by a second test head;
displacing the second test head along a measurement track parallel to the longitudinal extent of the welded joint;
determining acoustic properties in the microstructure based upon the relationship between the generated and received ultrasound surface waves; and
determining a degree of damage of the microstructure based upon the acoustic properties.

11. A method of testing microstructure of a welded joint for internal damage, for example due to material creep, comprising:
generating an ultrasound surface wave by a first test head;
receiving the ultrasound surface wave by a second test head;
displacing the first test head and second test head along a measurement track parallel to the longitudinal extent of the welded joint;
determining acoustic properties in the microstructure based upon the relationship between the generated and received ultrasound surface waves; and
determining a degree of damage of the microstructure based upon the acoustic properties.

12. The method as claimed in claim 9, further comprising:
determining a phase shift between the generated ultrasound surface wave and the received ultrasound surface wave; and
determining the acoustic properties in the microstructure based upon the phase shift.

13. The method as claimed in claim 10, further comprising:
determining a phase shift between the generated ultrasound surface wave and the received ultrasound surface wave; and
determining the acoustic properties in the microstructure based upon the phase shift.

14. The method as claimed in claim 11, further comprising:
determining a phase shift between the generated ultrasound surface wave and the received ultrasound surface wave; and
determining the acoustic properties in the microstructure based upon the phase shift.

15. The method as claimed in claim 12, wherein the two test heads are moved relative to one another in order to determine the phase shift between the generated ultrasound surface wave and the received ultrasound surface wave.

16. The method as claimed in claim 13, wherein the two test heads are moved relative to one another in order to determine the phase shift between the generated ultrasound surface wave and the received ultrasound surface wave.

17. The method as claimed in claim 14, wherein the two test heads are moved relative to one another in order to determine the phase shift between the generated ultrasound surface wave and the received ultrasound surface wave.

18. The method as claimed in claim 15, wherein the two test heads are moved relative to one another over a distance equal to the length of several wavelengths, and the wavelength of the ultrasound surface wave in the microstructure is averaged therefrom.

19. The method as claimed in claim 16, wherein the two test heads are moved relative to one another over a distance equal to the length of several wavelengths, and the wavelength of the ultrasound surface wave in the microstructure is averaged therefrom.

20. The method as claimed in claim 17, wherein the two test heads are moved relative to one another over a distance equal to the length of several wavelengths, and the wavelength of the ultrasound surface wave in the microstructure is averaged therefrom.

21. The method as claimed in claim 9, further comprising:
varying frequency of the generated ultrasound surface wave; and
determining the acoustic properties in the microstructure based upon a gradient of a corresponding variation in a wavelength of the received ultrasound surface wave.

22. The method as claimed in claim 10, further comprising:
varying frequency of the generated ultrasound surface wave; and
determining the acoustic properties in the microstructure based upon a gradient of a corresponding variation in a wavelength of the received ultrasound surface wave.

23. The method as claimed in claim 11, further comprising:
varying frequency of the generated ultrasound surface wave; and
determining the acoustic properties in the microstructure based upon a gradient of a corresponding variation in a wavelength of the received ultrasound surface wave.

24. The method as claimed in claim 12, wherein two test heads acting as receivers are set to phase coincidence of the ultrasound surface waves received by them in order to determine the phase shift.

25. The method as claimed in claim 14, wherein two test heads acting as receivers are set to phase coincidence of the ultrasound surface waves received by them in order to determine the phase shift.

26. The method as claimed in claim 9, wherein successive ultrasound surface waves, which have different wavelengths, are generated and received and the welded joint is tested layer by layer from the surface into its depth.

27. The method as claimed in claim 11, wherein successive ultrasound surface waves, which have different wavelengths, are generated and received and the welded joint is tested layer by layer from the surface into its depth.

28. The method as claimed in claim 11, wherein coarse-grid scanning of the welded joint is initially carried out and refined scanning of internal damage found in the microstructure is subsequently carried out.
